(19) United States
(12) Patent Application Publication
(10) Pub. No.: US 2009/0016687 A1
(43) Pub. Date: Jan. 15, 2009

(54) Optical fiber having waterproof function and method for manufacturing the same

(76) Inventors: Young-Ju Kang, Seoul (KR); Tae-Gyoung Kim, Busan (KR)

Correspondence Address: STROOCK & STROOCK & LAVAN LLP, 180 MAIDEN LANE, NEW YORK, NY, 10038, US

(21) Appl. No.: 12/152,493

(22) Filed: May 14, 2008

(30) Foreign Application Priority Data
May 15, 2007 (KR) 10-2007-0047139

(51) Int. Cl. G02B 6/02

(52) U.S. Cl. 385/128

(57) ABSTRACT

An optical cable having a waterproof function includes an optical fiber unit having at least one optical fiber, a tube surrounding the optical fiber unit, and a watertight material layer formed by coating a mixture of watertight material and binder to an inner wall of the tube. This optical cable allows easier fabrication and more convenient use.

### CROSS-REFERENCE TO RELATED APPLICATION

This application claims priority of Korean Patent Application No. 10-2007-0047139 filed on May 15, 2007, the entire disclosure of which is incorporated herein by reference.

### BACKGROUND OF THE INVENTION

1. Field of the Invention

The present invention relates to an optical cable having a waterproof function, and more particularly to an optical cable having a waterproof function, which allows easier fabrication and more convenient use.

2. Description of the Related Art

Generally, an optical cable may transmit a large amount of data rapidly in comparison to a coaxial cable, so the optical cable is widely used for transmitting electric or electronic signals in televisions, computers and phones. In order to protect an optical fiber against moisture, there are generally used three methods: inserting jelly compound into a tube of an optical cable, using a tape or yarn containing waterproof material, and inserting water-swellable powder into the tube.

The method of inserting jelly compound into a tube is inconvenient since jelly should be wiped using a jelly cleaner or alcohol when a tube is cut and then connected to another matter for divergence. In addition, the jelly compound may contaminate surroundings.

The method of using a tape or yarn containing waterproof material needs complicated processes and increased cost for manufacture since a separate device should be additionally required for inserting such a structure into a tube. FIG. 1 is a sectional view showing a conventional optical cable having a waterproof yarn; Referring to FIG. 1, the conventional optical cable having a waterproof yarn is configured such that an optical fiber core 1 and a waterproof yarn 3 are included in a tube 2, and a cable jacket 4 surrounds the tube 2. Since the waterproof yarn 3 is included in the tube 2 as a separate structure and then used for waterproofing, it is required to add a process of putting the waterproof yarn 3 when making the optical cable. In addition, the waterproof yarn 3 gives more inconvenience to a user who works with the optical cable.

Meanwhile, the method of inserting water-swellable powder into a tube may not give a waterproof effect for a sufficient time since the water-swellable powder may be not fixed but moved in the tube.

### SUMMARY OF THE INVENTION

The present invention is designed to solve the problems of the prior art, and therefore it is an object of the present invention to provide an optical cable having a waterproof function, which may allow easier fabrication and more convenient use.

In order to accomplish the above object, the present invention provides an optical cable having a waterproof function, which includes an optical fiber unit having at least one optical fiber; a tube surrounding the optical fiber unit; and a watertight material layer formed by coating a mixture of watertight material and binder to an inner wall of the tube.

Preferably, the watertight material layer is formed in a way that the mixture of watertight material and binder is coated on the inner wall of the tube using a double extruder while the tube is extruded.

As an alternative, the watertight material layer may be formed in a way that the mixture of watertight material and binder is coated on the inner wall of the tube using a pump while the tube is extruded.

Meanwhile, the watertight material is preferably water-swellable powder or SAP (super absorbent polymer).

More preferably, the water-swellable powder is any one selected from the group consisting of polyacrylate-based materials, reactants of PVA (polyvinyl alcohol) maleic acid, isobutylene maleic acid copolymer, polyacrylonitrile polymer, crosslinked polyethylene oxide, starch acrylonitrile polymer, and starch acrylic acid graft polymer.

Further, the optical cable having a waterproof function may further include a waterproof tape surrounding an outer wall of the tube.

In another aspect of the present invention, there is also provided a method for manufacturing an optical cable having a waterproof function, which includes an optical fiber unit, a tube surrounding the optical fiber unit, and a watertight material layer formed on an inner wall of the tube for waterproofing, wherein the method uses a double extruder including an extrusion dice, a first nipple positioned inside the extrusion dice, and a second nipple positioned inside the first nipple and having a hollow therein, wherein the method includes extruding a tube between the extrusion dice and the first tube; extruding a mixture of watertight material and binder between the first nipple and the second nipple and at the same time coating the mixture on an inner wall of the extruded tube to form a watertight material layer; and supplying an optical fiber unit through the hollow formed in the second nipple.

In addition, a gap between the first and second nipples of the double extruder is preferably adjustable to control a thickness of the formed watertight material layer.

Other objects and advantages of the present invention will be explained below, and they may be understood from embodiments of the present invention. Also, the objects and advantageous of the present invention may be realized using means defined in the appended claims or their combination.

### BRIEF DESCRIPTION OF THE DRAWINGS

Other objects and aspects of the present invention will become apparent from the following description of embodiments with reference to the accompanying drawing in which:

FIG. 1 is a sectional view showing a conventional optical fiber having a waterproof yarn;

FIG. 2 is a cross-sectional view showing an optical fiber having a waterproof function according to one embodiment of the present invention; and

FIG. 3 is a cross-sectional view showing a double extruder applied to manufacturing the optical cable having a waterproof function according to one embodiment of the present invention.

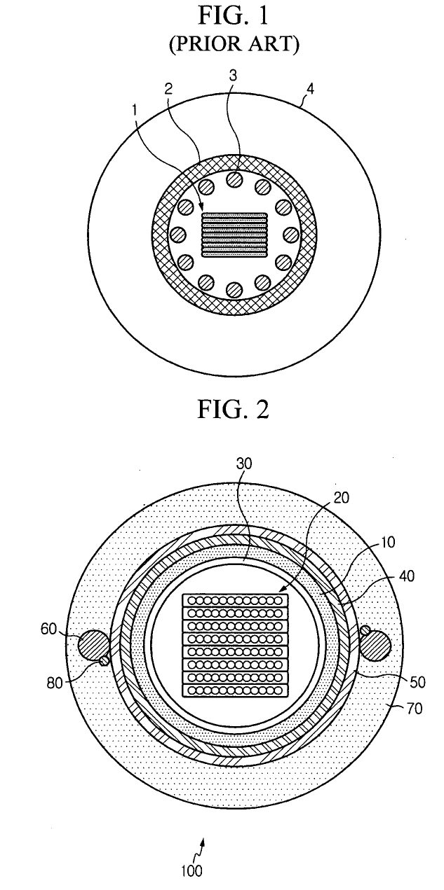

### REFERENCE NUMERALS OF ESSENTIAL PARTS IN THE DRAWINGS

10: tube
20: optical fiber unit
30: watertight material layer
40: waterproof tape
50: ECCS tape
60: galvanized steel wire stranded member
70: PE
80: ripcord

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 2 is a cross-sectional view showing an optical cable having a waterproof function according to one embodiment of the present invention.

Referring to FIG. 2, the optical cable 100 includes a tube 10, an optical fiber unit 20 installed in the tube 10, and a watertight material layer 30 coated on an inner wall of the tube 10.

At least one tube 10 is installed inside the optical cable 100. The tube 10 is made using plastic such as PP (polypropylene) and PBT (polybutyleneterephthalate).

A waterproof tape 40 is put around the tube 10, and an ECCS (electrolytic chrome coated steel) tape 50 is put around the waterproof tape 40. A galvanized steel wire stranded member 60 is symmetrically installed to an outer side of the ECCS tape 50, and PE (polyethylene) 70 is coated thereon. Here, the coated PE is called an outer jacket, and it is coated on an outer side of the tube 10 so as to protect the tube 10 against an external impact. Reference numeral 80 designates a ripcord.

The optical fiber unit 20 is installed in the tube 10 to transmit optical signals, and it has at least one optical fiber. Here, a structure in which a coating material is coated on at least one optical fiber arranged in parallel is called an optical fiber ribbon. For example, the optical fiber unit 20 may be configured such that six optical fiber ribbons, each having 12 optical fiber cores, are laminated.

The watertight material layer 30 absorbs moisture penetrated into the tube 10, and then watertight material is rapidly expanded due to the absorbed moisture to fill an empty space in the tube 10, thereby preventing moisture penetration in a length direction of the tube 10. The watertight material layer 30 is formed in a way of coating a mixture of watertight material and binder to an inner wall of the tube 10, and at this time a double extruder is used for the coating work. Also, the binder plays a role of assisting that the watertight material layer 30 coated on the inner wall of the tube 10 is adhered to the tube 10.

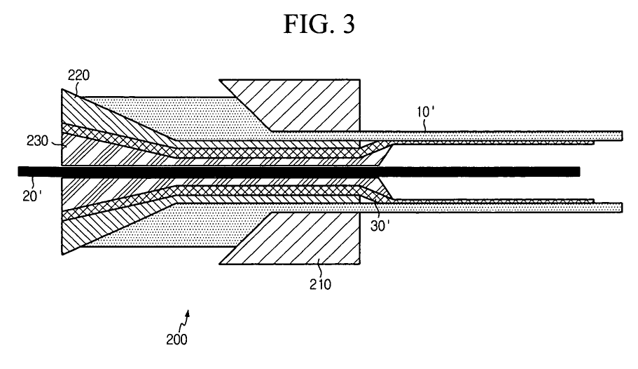

FIG. 3 is a cross-sectional view showing a double extruder used for manufacturing the optical cable having a waterproof function according to one embodiment of the present invention.

Referring to FIG. 3, the double extruder 200 employed in the present invention includes an extrusion dice 210, a first nipple 220 positioned inside the extrusion dice 210, and a second nipple 230 positioned inside the first nipple 220 and having a hollow therein.

The extrusion dice 210 is used for extruding a tube, and an extrusion hole is formed at its center. The first nipple 220 is installed at the center of the extrusion dice 210 and has a hollow therein. The first nipple 220 has an outer diameter smaller than an inner diameter of the extrusion hole formed in the extrusion dice 210. The second nipple 230 is installed in the hollow of the first nipple 220 and has a hollow therein. The second nipple 230 has an outer diameter smaller than an inner diameter of the hollow formed in the first nipple 220.

Now, a method for manufacturing an optical cable having a waterproof function according to one embodiment of the present invention using the double extruder shown in FIG. 3 will be explained.

Referring to FIG. 3, the tube 10 of the optical cable 100 is extruded through the extruder. At this time, extrusion is made through a space between the extrusion dice 210 and the first nipple 220 to form a tube 10′. Then, the watertight material layer 30 is formed. At this time, a mixture of watertight material and binder is extruded through a space between the first nipple 220 and the second nipple 230, and at the same time the mixture is coated on an inner wall of the tube 10 to form a watertight material layer 30′. Finally, an optical fiber unit 20′ is supplied through the hollow formed in the second nipple 230, and then installed in a space within the tube 10. After the above process, an optical fiber having a waterproof function is manufactured.

In addition, the watertight material layer 30′ coated on the inner wall of the tube 10 of the optical cable 100 as mentioned above has a thickness that may be controlled by adjusting a gap between the first and second nipples 220, 230 of the double extruder 200. In this configuration, the watertight material layer 30′ may be formed to have a thickness in the range of 0.2 mm to 1 mm.

As another embodiment, the watertight material layer 30 may be formed in a way of coating a mixture of watertight material and binder on the inner wall of the tube 10 by means of a pump while the tube 10 is extruded.

The watertight material layer 30 is formed in a way that a mixture of watertight material and binder is coated on the inner wall of the tube 10. At this time, the watertight material may employ water-swellable powder or SAP (super absorbent polymer).

In addition, the water-swellable powder may employ polyacrylate-based materials, reactants of PVA (polyvinyl alcohol) maleic acid, isobutylene maleic acid copolymer, polyacrylonitrile polymer, crosslinked polyethylene oxide, starch acrylonitrile polymer, starch acrylic acid graft polymer, sarin-based materials, and so on. Among the above, polyacrylate-based materials show a rapid absorption speed and good absorption ratio.

The water-swellable powder may be added with PVA having improved flame resistance, polyethylenoxide, sulfone group, sulfate group, phosphate group, and so on.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

As described above, the optical cable having a waterproof function according to the present invention gives a waterproof function by coating a watertight material layer on an inner wall of a tube, and also allows easier fabrication and more convenient use to a user who works with the optical cable, in comparison to the conventional one.

In addition, since the watertight material layer acting as a waterproof layer is coated using a double extruder, the optical cable of the present invention may be manufactured using a simple process in comparison to the conventional one.

What is claimed is:

1. An optical cable having a waterproof function, comprising:
an optical fiber unit having at least one optical fiber;
a tube surrounding the optical fiber unit; and
a watertight material layer formed by coating a mixture of watertight material and binder to an inner wall of the tube.

2. The optical cable having a waterproof function according to claim 1,
wherein the watertight material layer is formed in a way that the mixture of watertight material and binder is coated on the inner wall of the tube using a double extruder while the tube is extruded.

3. The optical cable having a waterproof function according to claim 1,
wherein the watertight material layer is formed in a way that the mixture of watertight material and binder is coated on the inner wall of the tube using a pump while the tube is extruded.

4. The optical cable having a waterproof function according to claim 1,
wherein the watertight material is a water-swellable powder or a super absorbent polymer.

5. The optical cable having a waterproof function according to claim 4,
wherein the water-swellable powder is any one selected from the group consisting of polyacrylate-based materials, reactants of polyvinyl alcohol maleic acid, isobutylene maleic acid copolymer, polyacrylonitrile polymer, crosslinked polyethylene oxide, starch acrylonitrile polymer, and starch acrylic acid graft polymer.

6. The optical cable having a waterproof function according to claim 1, further comprising a waterproof tape surrounding an outer wall of the tube.

7. A method for manufacturing an optical cable having a waterproof function, which includes an optical fiber unit, a tube surrounding the optical fiber unit, and a watertight material layer formed on an inner wall of the tube for waterproofing,
wherein the method uses a double extruder including an extrusion dice, a first nipple positioned inside the extrusion dice, and a second nipple positioned inside the first nipple and having a hollow therein,
wherein the method comprises:
extruding a tube between the extrusion dice and the first tube;
extruding a mixture of watertight material and binder between the first nipple and the second nipple and at the same time coating the mixture on an inner wall of the extruded tube to form a watertight material layer; and
supplying an optical fiber unit through the hollow formed in the second nipple.

8. The method for manufacturing an optical cable having a waterproof function according to claim 7,
wherein a gap between the first and second nipples of the double extruder is adjustable to control a thickness of the formed watertight material layer.
